(19) United States
(12) Patent Application Publication
(10) Pub. No.: US 2015/0115677 A1
(43) Pub. Date: Apr. 30, 2015

(54) Child Seat and an Impact Shield for a Child Seat for a Vehicle

(71) Applicant: CYBEX GMBH, Bayreuth (DE)

(72) Inventor: Martin Pos, Bayreuth (DE)

(21) Appl. No.: 14/375,703

(22) PCT Filed: Jun. 18, 2012
(86) PCT No.: PCT/EP2012/061580

§ 371 Date: Jan. 7, 2015

(30) Foreign Application Priority Data
Jan. 30, 2012 (DE) 10 2012 100 707.1

(51) Int. Cl. B60N 2/28; B60N 2/26

(52) U.S. Cl. CPC B60N 2/2839; B60N 2/2821; B60N 2/265; B60N 2/2851
USPC 297/256.15; 297/468

(57) ABSTRACT

A child seat for a vehicle, particularly a motor vehicle, comprises a base element, if required a back element and/or side elements, as well as an impact shield that can interact with a belt system so as to retain a child. At least two belt section receiver-devices are provided on the impact shield which allow at least two belt sections to be arranged one next to the other, said two belt sections having an offset to one another in at least some sections and transverse to their longitudinal extension.

### CROSS REFERENCE TO RELATED APPLICATIONS

This application is the U.S. national phase of International Patent Application No. PCT/EP2012/061580 filed Jun. 18, 2012, which claims the benefit of German Application No. 10 2012 100 707.1 filed Jan. 30, 2012, the entire content of which is incorporated herein by reference.

### BACKGROUND

Disclosed herein is a child seat for a vehicle, in particular a motor vehicle, comprising a base element, if required a back element and/or side elements as well as an impact shield which is able to cooperate with a belt system for retaining the child, as well as an impact shield for a child seated in a vehicle, in particular a motor vehicle.

A child seat comprising an impact shield is disclosed, for example, in the German utility model DE 20 2009 013 376 U1. Such impact shields, in particular in the event of an accident or sudden braking, are intended to retain a child, who is seated in a child seat, in the seat. Such impact shield systems may be used on the passenger seat or the rear seat bench and may cooperate with (conventional) three-point belts or a two-point belt (lap belt). The lap belt or lap belt portion of a three-point belt generally runs in a groove-shaped recess extending transversely in the impact shield or bears against the outer face thereof.

Generally, such impact shields may be used in a child seat with or without a backrest and with or without side rests. The impact shield may bear against the thighs of the child and/or against the child seat. Alternatively, the impact shield may also be supported on a vehicle seat. In particular with large children, impact shields are also used without an associated child seat. In this case, the (older) child sits directly on the vehicle seat and the impact shield is fastened thereto and/or to the vehicle.

In the event of sudden braking or even a front impact of the vehicle, the upper body of the child is forced onto the surface (inner face) of the impact shield. Thus the impact shield is often provided with a foam or padded insert in order to avoid injuries.

If the impact shield itself is fixed to the child seat, said child seat may be fastened in turn to a vehicle seat and/or to the vehicle. To this end, in the prior art the seat is often fastened to a base which is provided, for example, with an ISOFIX mounting which is able to be fastened to ISOFIX fastening points on the seat, namely to transverse bolts. Additionally, embodiments are disclosed in DE 20 2009 013 376 U1 in which the child seat is fastened via a belt to the vehicle seat.

A fundamental problem with the impact shields known from the prior art is that the child, for example in the event of an accident, travels a relatively long distance before it is decelerated by the impact shield. In an extreme case, even the head of the child may strike against a front seat or a fitting. In order to reduce such dangers, German patent document DE 10 2004 007 768 A1 proposes an airbag inside the impact shield. As a result, in the event of an accident, in particular the upper body of the child is intended to be held back. Overall, however, the disclosed airbag device is relatively complex, in particular in terms of construction.

In German utility model DE 20 2009 005 205 U1, through-holes in the child seat are proposed in order to receive guide projections of the impact shield. Via the guide projections, force is intended to be introduced into the side wall of the child seat, if a force is exerted onto an upper part of the impact shield. This measure is also relatively complex in terms of construction. Moreover, the impact shield is only able to be adapted relatively poorly to the size of child.

### SUMMARY

Disclosed herein is a child seat for a vehicle and/or an impact shield which retains the child securely in the child seat and/or on the vehicle seat in a structurally simple manner; in particular a rotation of the upper body of the child in the event of an accident is intended to be relatively small. This object is achieved by a child seat as claimed in claim 1 as well as an impact shield as claimed in claim 14.

The child seat for a vehicle (in particular a motor vehicle) comprises a base element (if required a back element and/or if required side elements) as well as an impact shield which is able to cooperate with a belt system for retaining a child, wherein at least two belt portion receiver devices are provided on the impact shield such that at least two belt portions may be arranged adjacent to one another, wherein the two belt portions have an offset relative to one another and transversely to the longitudinal extent thereof.

A fundamental feature is to provide not only one (transversely extending) belt portion but two (transversely extending) belt portions for retaining the impact shield and/or the child, wherein the two belt portions have an offset relative to one another. This means that (in the mounted state) at least one upper and/or rear belt portion and (in the mounted state) at least one lower and/or front belt portion are provided. As a result, a rotation of the child is counteracted in a structurally simple manner if the lower (front) belt portion holds the child back. This, in particular, rearwardly acting retaining force of the lower (front) belt portion, would normally result in a rotation of the upper body of the child. This is counteracted by the upper (rear) belt portion which forces (and/or retains) the child in the direction of the seating surface of the child seat and/or vehicle seat. As a result, the security of the seat of the child is increased in a simple manner.

The impact shield may be produced from plastics and preferably comprises padding (in particular foam padding). The impact shield may be of (substantially) planar configuration and, for example, may be (approximately) two to four times as wide as it is long. The belt portion receiver devices may serve for retaining (securing) corresponding belt portions and may be configured as belt portion guide devices. The belt portion receiver devices may comprise, for example, a groove (transverse groove) and/or retaining webs and/or receiving pockets and/or receiving slots.

In a practical embodiment an (in particular continuous) belt is provided, said belt preferably comprising at least two belt portions arranged adjacent to one another. In such an embodiment, excessive rotation is reliably prevented by structurally simple means.

“Offset” is intended to be understood, in particular, in that a central line of the respective belt portion is spaced apart relative another. The belt portions may also be spaced apart relative to one another. “Adjacent arrangement” is intended to be understood, in particular, in that the belt portions extend, for example, in parallel (with regard to a line of force action) and are not arranged one behind the other, i.e. extend in series. In a practical embodiment, the belt portions may also extend parallel in the geometric sense (at least partially).

Preferably, in one or both side regions of the child seat at least one belt is fastened and/or is able to be fastened and/or is deflected and/or is able to be deflected. The corresponding fastening may comprise a quick release fastener. The quick release fastener preferably comprises a plug connection, for example comprising a lock tongue and/or a (slotted) lock element (tongue receiver element). In such an embodiment, a simple and secure retention of the impact shield in the child seat and/or vehicle seat may be ensured.

In a practical embodiment, the at least two adjacently arranged belt portions, in the mounted state of the receiver body, extend (substantially) horizontally (in the transverse direction) and/or extend parallel to one another. In such an embodiment, a rotation of the upper body of the child is counteracted in a simple manner. The belt portions, however, may also extend at an angle (for example of 20 to 40 degrees) from the horizontal. Moreover, the belt portions may be at an angle relative to one another (for example 20 to 50 degrees). At this point it should be made clear that the belt portions do not have to extend in a straight line over the entire length thereof, but may also be curved or undulating.

At least one belt deflection point (in the mounted state of the child seat and/or the impact shield) may be at an angle of less than or equal to 90 degrees, preferably less than or equal to 60 degrees, further preferably less than or equal to 45 degrees, even further preferably less than or equal to 30 degrees. Additionally or alternatively, this angle may be greater than or equal to 5 degrees, preferably greater than or equal to 20 degrees. In an alternative embodiment, (alternatively or additionally) the belt deflection point is pivotable, in particular freely pivotable. By means of such embodiments, a secure retention of the child seat and/or the child is ensured in the event of sudden braking.

The belt and/or at least one belt portion may have at least one, in particular at least two, belt length adjustment devices. As a result, the impact shield may be adapted to the child, which increases the safety.

In a practical embodiment, at least one retaining and/or positioning device, in particular a retaining and/or positioning tab and/or loop, is provided (for at least one belt portion and/or the belt). As a result, the path of the belt and/or belt portion may be clearly defined, which reduces the risk of excessive rotation of the impact shield.

In the mounted state of the impact shield and when loaded by a force acting in the direction of travel (inertial force of the child) a retaining force provided by an upper belt portion may be at least as high or preferably higher (for example at least 10% or 20%) than the retaining force which is provided by a lower belt portion. The lower belt portion may correspond to a front belt portion. The upper belt portion may correspond to a rear belt portion. By a corresponding dimensioning of the impact shield and/or the child seat, increased force may be provided in the direction of the seat surface. As a result, the child seat and/or the child is securely retained.

In various embodiments, the offset may correspond to at least one belt width, preferably at least 1.5 belt widths, further preferably at least 2 belt widths. In practice, the offset may be at least 5 cm, preferably at least 7.5 cm, even further preferably at least 10 cm. By such measures, the risk of undesired rotation is reduced.

An upper (rear) belt portion and a lower (front) belt portion at their respective fastening portion may form an angle (of for example greater than 0 degrees or greater than 15 degrees or greater than 30 degrees). Moreover, portions of the belt adjacent to a deflection point may be at an angle relative to one another (of for example greater than 0 degrees or greater than 15 degrees or greater than 30 degrees). As a result, a direction of the acting forces is influenced such that the child seat is retained in both the rearward and downward directions. The risk of undesired rotation of the child is reduced.

An inner face of the impact shield may be configured to be at least partially trough-shaped. The inner face of the trough element is intended to be, in particular, the side which faces the child during use. The impact shield may have side cheeks, in particular oriented in the direction of the child. Overall, the child is thus retained more securely by the impact shield. Preferably, edges of the impact shield and/or side cheeks of the impact shield merge with the side rests of the child seat. As a result, an enclosed shell is formed, which protects the child in a particularly reliable manner. In the prior art, impact shields are proposed, the outer face thereof being of trough-shaped configuration and/or having a (wide) outer groove. In particular in the event of transverse forces, these impact shields are disadvantageous.

At least one side portion (preferably both side portions) of the impact shield may be curved inwardly (in the direction of the child during use).

An upper portion of at least one side portion may have a projection on which (above which) preferably an end portion of an upper belt guide is arranged. If the belt guide is forced outwardly by the projection, it is ensured that the point of application of force is relatively high up. As a result, a rotation of the impact shield is counteracted in a simple manner.

The aforementioned object is achieved independently by an impact shield for a child seat for a vehicle, in particular a motor vehicle, and/or for a child seated on or in a vehicle, wherein the impact shield is able to cooperate with a belt system or comprise such a belt system for retaining the child, wherein at least two belt portion receiver devices are provided on the impact shield such that at least two belt portions may be arranged adjacent to one another, wherein the two belt portions have an offset relative to one another (transversely to the longitudinal extent thereof).

By means of the proposed belt guide which acts via a belt deflection point on the impact shield in the event of increasing speed/mass which acts on the impact shield, such that the impact shield is retained not only in the rearward direction but also in the downward direction (to a certain extent “is forced back into the seat”), the energy dissipation in the case of an impact (sudden braking) may be initiated substantially earlier. After corresponding tests using a dummy, it has been established that the acting forces may be reduced by (approx.) 30 to 40%. This represents a considerable improvement relative to the prior art.

Further embodiments are revealed from the subclaims.

### BRIEF DESCRIPTION OF THE DRAWINGS

An exemplary embodiment with regard to further features and advantages is described in more detail by means of the drawings, in which:

FIG. 1 shows a first embodiment of the child seat in an oblique view;

FIG. 2 shows an impact shield in an oblique view.

### DETAILED DESCRIPTION

In the following description of the figures, the same reference numerals are used for the same parts and/or parts performing the same function.

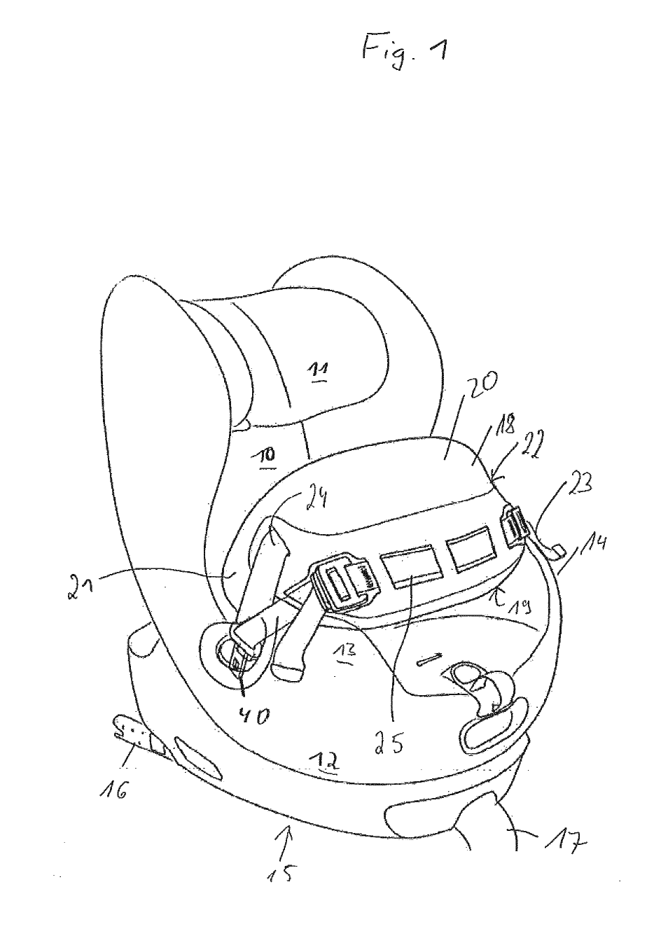

FIG. 1 shows a child seat in an oblique view. The child seat has a back element (backrest) 10, a headrest 11, a base element 12 as well as side elements (side rests; armrests) 13 and 14. The child seat is able to be fastened via a supporting and retaining device 15 by a fastening means 16 and a (partially shown) support foot in a vehicle (motor vehicle) and/or able to be supported therein.

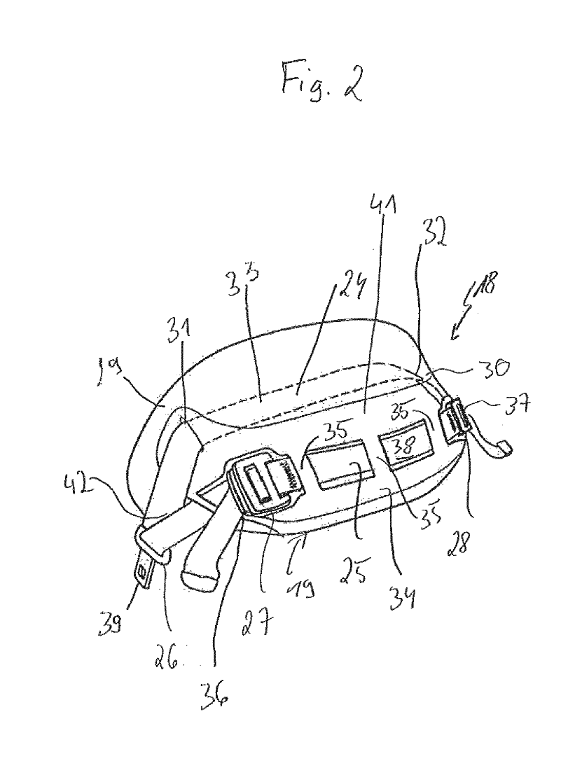

An impact shield (see also FIG. 2) is identified by the reference numeral 18. The impact shield 18 has a planar (approximately rectangular) basic shape and is configured overall to be trough-shaped, wherein an inner face 19 which opposes an outer face 20 is of trough-shaped configuration. In practice, the impact shield 18 has side cheeks 21, 22, wherein due to the oblique view in FIGS. 1 and 2 the side cheek 22 is not able to be identified in detail. These side cheeks 21, 22 face (approximately) obliquely to the rear, i.e. in the direction of the seated child.

By means of the side cheeks (projections) 21, 22, both a guidance of a belt portion (further details thereof below) and a securing of the child, in particular in the event of transverse forces, are implemented by only one element (which is extremely simple structurally). As a result, the production costs may be reduced as a whole with a high degree of functionality.

A belt 23 is guided in the impact shield 18. The belt 23 comprises an upper belt portion 24 and a lower belt portion 25 (see also FIG. 2). The belt portions 24, 25 merge into one another and are deflected at their ends by deflection point elements 26 (of which only one may be seen in the oblique view according to FIGS. 1 and 2). As a whole, the belt 23 is thus configured to be continuous. Belt length adjustment devices 27 and 28 permit an adjustment and positioning of the impact shield with regard to the child to be received.

As may identified, in particular, in FIG. 2, the upper belt portion 24 and lower belt portion 25 extend adjacent to one another and partially (substantially) in parallel. For receiving and/or guiding the upper belt portion 24, guiding and retaining slots 31, 32 are provided at lateral ends 29, 30 of the impact shield 18. A central portion 33 of the upper belt portion 24 extends on the inner face 19 of the impact shield 18.

The lower belt portion 25 is retained by a receiving pocket 34 on the impact shield 18. The receiving pocket 34 has retaining tabs 35 which retain the lower belt portion 25 in the pocket 34. The belt length adjustment devices 27, 28 are provided at the ends 36, 37 of a central portion 38 of the lower belt portion 25. As a result, the length of the entire belt 23 and the length of the upper belt portion 24 may be adjusted solely via the lower belt portion 25. This simplifies the handling of the child seat. The deflection point element 26 has a latching tongue 39 which (see FIG. 1) may be inserted into a latching receiver 40. A deflection point element, optionally with a latching tongue and latching receiver, may also be provided at the deflection point, not shown in the figures.

As may be identified in FIG. 2, the belt portions 24, have an offset 41 in their central portion, said offset corresponding to (approximately) twice the belt width. The offset 41 is reduced in the direction of the deflection point elements 26. At least the central portions of the belt portions 24, 25 extend (approximately) horizontally and parallel to one another. In the region of the deflection point in the deflection point element 26 the belt portions 24, 25 are at an angle 42 relative to one another. This angle is (approximately) 30 degrees.

At this point is should be mentioned that all of the above-described parts are claimed as essential to the invention disclosed herein when taken individually and in any combination, in particular the details shown in the drawings. Alterations thereto are familiar to the person skilled in the art.

### LIST OF REFERENCE NUMERALS

10 Back element
11 Headrest
12 Base element
13 Side element
14 Side element
15 Supporting and retaining device
16 Fastening means
17 Support foot
18 Impact shield
19 Inner face
20 Outer face
21 Side cheek
22 Side cheek
23 Belt
24 Upper belt portion
25 Lower belt portion
26 Deflection point element
27 Belt length adjustment device
28 Belt length adjustment device
29 Lateral end
30 Lateral end
31 Guiding slot
32 Guiding slot
33 Central portion
34 Receiving pocket
35 Tab
36 End
37 End
38 Portion
39 Latching tongue
40 Latching receiver
41 Offset
42 Angle

1. A child seat for a vehicle, comprising:
a base element;
if required a back element and/or side elements; and
an impact shield which is able to cooperate with a belt system for retaining a child;
characterized in that at least two belt portion receiver devices are provided on the impact shield such that the at least two belt portions may be arranged adjacent to one another, wherein the at least two belt portions have an offset relative to one another at least in some sections and transversely to the longitudinal extent thereof.

2. The child seat for a vehicle, as claimed in claim 1, characterized in that at least one continuous belt is provided, said belt preferably comprising at least two belt portions arranged adjacent to one another.

3. The child seat for a vehicle, as claimed in claim 1, characterized in that in one or both side regions of the child seat at least one belt is fastened and/or is able to be fastened and/or is deflected and/or is able to be deflected, wherein the fastening preferably comprises a quick release fastener, in particular comprising a plug connection, preferably comprising a lock tongue and/or an optionally slotted lock element.

4. The child seat for a vehicle, as claimed in claim 1, characterized in that the at least two adjacently arranged belt portions, in the mounted state of the impact shield, extend at least partially horizontally and/or extend parallel to one another.

5. The child seat for a vehicle, as claimed in claim 1, characterized in that at least one belt deflection point, in the mounted state of the child seat and/or the impact shield, is at an angle of less than or equal to 90 degrees, preferably less than or equal to 60 degrees, further preferably less than or equal to 45 degrees, even further preferably less than or equal to 30 degrees and/or an angle of greater than or equal to 5 degrees, preferably greater than or equal to 20 degrees and/or preferably is freely pivotable.

6. The child seat for a vehicle, as claimed in claim 1, characterized in that the belt and/or a belt portion has at least one, in particular at least two, belt length adjustment devices.

7. The child seat for a vehicle, as claimed in claim 1, characterized in that at least one retaining and/or positioning device, in particular a retaining and/or positioning tab and/or loop, is provided for at least one belt portion.

8. The child seat for a vehicle, as claimed in claim 1, characterized in that, in the mounted state of the impact shield and when loaded by a force acting in the direction of travel, a retaining force provided by an upper belt portion is at least as high, preferably higher, than the retaining force which is provided by a lower belt portion.

9. The child seat for a vehicle, as claimed in claim 1, characterized in that the offset is at least one belt width, preferably at least 1.5 belt widths, even further preferably at least two belt widths and/or at least 5 cm, preferably at least 7.5 cm, even further preferably at least 10 cm.

10. The child seat for a vehicle, as claimed in claim 1, characterized in that an upper belt portion and a lower belt portion at their respective fastening portion form an angle and/or portions of the belt adjacent to a deflection point are at an angle relative to one another.

11. The child seat for a vehicle, as claimed in claim 1, characterized in that an inner face of the impact shield which faces the child during use, is configured to be at least partially trough-shaped.

12. The child seat for a vehicle, as claimed in claim 1, characterized in that at least one side portion of the impact shield is curved inwardly in the direction of the child during use.

13. The child seat for a vehicle, as claimed in claim 1, characterized in that an upper portion of at least one side portion has a projection on which preferably an end portion of the upper belt guide is arranged.

14. An impact shield for a child seat for a vehicle, and/or for a child seated on a vehicle seat, as a component of the child seat as claimed in claim 1, wherein the impact shield is able to cooperate with a belt system for retaining a child, characterized in that at least two belt portion receiver devices are provided on the impact shield such that at least two belt portions may be arranged adjacent to one another, wherein the two belt portions have an offset relative to one another at least in some sections and transversely to the longitudinal extent thereof.
